(19) United States
(12) Patent Application Publication
(10) Pub. No.: US 2026/0308397 A1
(43) Pub. Date: Oct. 8, 2026

(54) PAINT WITH LOW LIGHT REFLECTIVITY AND LOW FOGGING

(71) Applicant: SURREY NANOSYSTEMS LIMITED, Newhaven, Newhaven Sussex (GB)

(72) Inventors: Ben Poul JENSEN, Eastbourne, Sussex (GB); Adam Thomas KERRY, Gillingham, Kent (GB); Georgina WRIGHT, Great Bentley, Essex (GB); Madeline Cecilia DENCH, Whitby, Yorkshire (GB); Alexander George DARNLEY, Witham, Essex (GB); Gesine HERMANN, Rustington, West Sussex (GB)

(21) Appl. No.: 19/481,149

(22) PCT Filed: May 2, 2024
(86) PCT No.: PCT/GB2024/051161

§ 371 Date: Nov. 3, 2025

(30) Foreign Application Priority Data
May 5, 2023 (GB) 2306695.4

(51) Int. Cl. C09D 5/32; B05D 1/02; C09D 7/40; C09D 7/61; C09D 183/04

(52) U.S. Cl. CPC C09D 5/32; B05D 1/02; C09D 7/61; C09D 7/67; C09D 7/68; C09D 7/69; C09D 183/04

(57) ABSTRACT

A method of coating a substrate to form a light absorbing, non-transparent film, includes the steps of: (a) providing a suspension in a solvent of: (i) a pigment, (ii) a binder which includes a polysiloxane, a polyol, or a combination thereof, (iii) a rheology modifier, and (iv) an adhesion promoter which includes a silane group; (b) spray-coating the suspension onto the substrate with the majority of the solvent evaporating before the suspension contacts the substrate in order to result in a porous coating; (c) repeating step (b) until the average coating thickness is at least 20 micrometres; and (d) curing the coating in order to result in a delta-haze of less than 1 (measured to ASTM-D1003-21 through glass) and a fog number of at least 95 fog numbers as measured by an extended SAE-J1756 photometric test at 120° C. for 168 hrs with a 21° C. collector plate temperature.

### TECHNICAL FIELD

The present invention relates to the manufacture and application of a very low reflectivity, black coating which has low fogging and haze generation and is used to protect Automated Driver Assistance System (ADAS) sensors from stray light.

### BACKGROUND OF THE INVENTION

The use of imaging systems in cars in now common with a significant percentage of new cars using camera systems to enhance driver safety. Camera systems are generally protected from sunlight and veiling glare by shields that use variety of techniques to absorb stray light. One such example can be seen in US patent application: US20210306537-Vehicular windshield-mounted forward viewing camera with coated stray light shield region of housing.

Automated Driver Assistance Systems (ADAS) are a range of technologies (both hardware and electronic) that are designed to assist drivers during the driving and parking process. They are designed to help reduce road deaths from driver error by automating some driver functions and use different types of sensor systems to understand the environment surrounding the car.

The key external looking sensors used in ADAS systems are as follows: camera systems (forward, side and rear), long and short-range radar, ultrasonic and LiDAR.

Sensors that use visible or infrared light such as cameras and LiDAR must be protected from stray light from the sun and surrounding environment such as oncoming headlights and overhead street lighting. If the sensors are not protected, stray light can cause veiling glare or image washout causing the sensor to go ‘blind’ or to have its performance degraded so that the ADAS system fails to function correctly.

As cars become more automated with more advanced computer controlled self-driving functions, then having sensor systems failing through poor stray light control may lead to accidents.

Most systems designed to protect these sensors from stray light use a combination of baffles and light absorbing coatings and are generally known as glareshields in the automotive industry. In ADAS systems, forward and side cameras tend to be surrounded by injection moulded polymer glare shields that use textured surfaces, black flocks, moulded baffle ridges or simple black paints to minimise the stray light that reaches the camera. For ADAS 1 functions such as adaptive cruise control, emergency brake assist, automatic emergency brake assist, lane-keeping, and lane centering these designs work to an acceptable level. As ADAS functionality increases to ADAS Level 2 (ISO2), where auto parking and other features which allow the car to accelerate, brake and steer all on its own are implemented, sensor protection becomes more critical. ADAS Level 2 requires the driver to still be always attentive and remain in the drivers' seat. The driver can take over control anytime they wish to or urgently when the ADAS control system ‘drops out’ whilst the vehicle is moving at speed. Drop out usually happens in difficult lighting conditions when the signal to noise ratio of the sensor exceeds the software safety limits.

As we move beyond ADAS 2 to level 3, 4 and 5 the level of human interaction with the car drops significantly so at level 5 the car is fully autonomous and has no steering wheel or driving control system for a passenger to interact with. Any failure with ADAS Level 2+ optical sensors or anything that degrades their ability to accurately determine the environment surrounding a car moving at speed has significant potential to cause the car to either halt in place or get into an unsafe driving situation where the control system may not detect fixed objects, moving cars or pedestrians.

Because of these advances in automation, stray light control and camera shield design has become far more critical, and the traditional black light absorbing coatings used to control stray light no longer work to an acceptable level of performance as they degrade and contaminate the sensors and windshield through thermal fogging or outgassing over the life of the car, or they contain materials such as carbon nanotubes or graphene that are potentially dangerous to passengers within the passenger cabin so are not acceptable to the automotive industry. With the arrival of wide field of view (FOV) glareshields and glareshields with multiple cameras fitted, then the increased shield surface area adds significantly to the stray light challenge and by having a larger surface area of applied coating that will fog.

Historically, functional, non-aesthetic automotive black paints have been manufactured from a range of functionalised metal oxide or amorphous carbon pigments combined with a binder, a stabilising agent such as a surfactant or dispersing agent, a bonding agent and solvent carrier systems that could be aqueous or VOC based. They may also contain anti foaming agents, UV stabilizers and biocides. These functional, non-aesthetic automotive matt black paints used as light absorbers were not concerned with very low levels of fogging as there was no requirement for this attribute in early ADAS systems so coating manufacturers never tested or investigated the parts of the coating that contributed to fogging until recently, and just assumed it could be reduced to an acceptable level by post spray baking after ADAS manufacturers noticed a drop in optical performance through condensed fog on the windshield and camera lens.

Note: The automotive term ‘low-fogging or fogging’ used in this application should not be confused with anti-fogging, low-fogging, anti-misting, or low-misting type surface coatings or treatments that are designed to protect the coated object (like a mirror) from misting or fogging in a humid environment such as a shower room (such as that disclosed in US 2012/0295084 A1). These types of super-hydrophobic coatings may also be tinted with a pigment to colour the glass or surface they are applied to. By contrast, in terms of this application, low fogging means a black, non-translucent coating that absorbs light, and that when hot in dry or humid conditions does not release condensable material (fog) that collects on a glass or optical surface thereby obscuring the view through the glass or lens.

Also note, that when sunlight hits the condensed fog on the windshield glass it tends to cause a diffuse flare on the windshield from certain sun positions. This flare limits the camera field of view even further leading to increasingly poor performance and safety.

With increasing automation and stringent safety requirements in automotive systems, the use of light absorbing coatings that fog and degrade sensor performance over the life of the car are no longer acceptable. The more autonomous the driving functions become, the more critical it is that they don't degrade, so a new light absorbing solution is needed. One that overcomes the limitations of existing black coatings and baffles used to trap light in ADAS camera shields and automotive Head Up Display (HUD) systems.

Today, typical camera shield coatings are as follows: Vantablack VBx2 (produced by the present applicant and disclosed in WO 2019/073210), conventional matt black paints such as Nextel Black, and 3D forming polymer-based materials like black flocking. Nanomaterial based super-black coatings that use carbon nanotubes have also been proposed but in reality they are too fragile, costly to apply and create and are significant irritants to human and animal mucus membranes so are not used inside passenger cabins despite their excellent THR performance and potentially low outgassing or fogging performance.

In terms of optical performance, Vantablack VBx2 and black flocking have a similar Total Hemispherical Reflectance (THR) of about 1.1% in the visible spectrum and an excellent ability to trap light from any angle, though because of its polymer fibre structure, flock sparkles quite badly in direct sunlight. Black paints typically have THRs between 3-10% but have poor angular performance or ability to trap photons from any arrival angle. In terms of optical desirability, the lower the THR the better the shield can trap stray light and it is also easier for the camera software to detect the difference between the shield coating and road tarmac. Also, having an absorber coating that can efficiently trap stray light from all arrival angles is very desirable as the sun is in different overhead positions throughout the day and at different times of the year.

For use in automotive ADAS systems, coatings ideally have additional functionality as well as a low THR. Other preferred attributes are as follows: low fogging, low delta haze, good thermal stability, good resistance against environmental degradation, good shock and vibration stability, resists coating damage during manufacture and assembly, and the ability to be applied by simple and repeatable means on to moulded polymer shields in an automotive production environment. Cost per part is also a major driver in automotive production so any solution that provides the above desirable attributes and has a low total applied cost, has significant commercial value.

Whilst all the above-mentioned coatings exhibit some of these desirable properties, there are none that exhibit all of them. The most critical functional properties of the coating are THR, fogging plus the derived delta-haze, handling, and UV/thermal stability. In automotive terms, fogging or outgassing happens to a material when it heats up in sunlight and releases volatile condensable material that collects on the windshield or system camera optics causing the camera field of view to be reduced or severely degraded over time. To the ADAS camera this contamination looks like the car is driving through a foggy environment so causing the control system to take longer to identify external objects, misidentify or to totally miss them altogether. Fogging is made worse from hydrolytic degradation of the coating through exposure to high levels of humidity combined with heat from the sun. The moisture and heat help break down polymeric binders or functional groups on the pigments within a coating causing it to fog more rapidly and making the fog very adherent to the windshield glass. Almost all conventionally manufactured polymer-based paints and functionalised pigments suffer from thermal fogging and hydrolytic degradation, with typical paint fog numbers from 18-90, where 100 is no detectable fog.

The automotive Industry uses standard tests to determine the fogging rate of materials: SAE J1756, ISO6452 and DIN75201. These standard tests can be modified by duration and temperature to simulate the fogging behaviour of a coating or part over the life of the car. Unless explicitly stated otherwise, the fog numbers referred to in this patent are derived from an extended SAE-J1756 photometric test where materials are exposed to 120° C. for 168 hrs with a 21° C. collector plate temperature. This extended test simulates a greater than 6-year operational period in a hot climate and should not be confused with the standard SAE J1756 test which is 100° C. for 3 hrs, which is far less challenging.

As camera shield coatings are intentionally black, and they see direct sunlight for most of daylight hours when the sky is clear, then it is obvious that the shields will get hotter than the general internals of the car exposed to the same sunlight. In many cases, camera shields in hot climates can reach over 100° C. during the hottest parts of the day. This means that any coating applied must be exceptionally resistant to fogging and be thermally stable through the full life of the car or the ADAS camera performance will be degraded. This is exacerbated in tropical climates where heat with high levels of humidity rapidly cause coating hydrolytic degradation. Again, this leads to a reduction in camera performance as the condensed fog starts to restrict the camera view through the windshield. The fog generated from the coating can also build up on the camera lenses directly which causes an even greater safety challenge as any drop in performance with the camera lens has a direct impact on the ADAS control system and camera software.

A measure of the change in light transmission through glass from fog build up is the delta-haze value. Delta-haze is measured to ASTM-D1003-21 using a suitable transmission measuring system. To measure delta haze light transmission is measured through the glass at the start of the trial and then the glass is subjected to the light absorbing coating in a fogging system designed to thermally simulate the shield temperatures and environment over the life of a car. After the test has completed, the haze is remeasured and then the starting haze is subtracted from the final haze to give the delta-haze percentage. In this way you can understand how the optical performance of the windshield will change from any fogging over the life of the car.

In the case of a glareshield and their coatings, a high delta haze means that the glass transmission has dropped through fog condensation (hazing). A desirable delta haze is less than 1 over the life of the car so it measured after the extended SAE J1756 fog trial. Anything over 1 means that it is likely there will be an unacceptable drop in performance of the optical cameras. Paints, even after prolonged baking to remove volatile materials, tend to give a delta haze value over 5, whilst the best flocks after 12 hr baking are still over 2.

It should also be noted that the SAE fog tests do not take into account the behaviour of the coating in hot humid environments where hydrolytic degradation occurs as the test takes place in a sealed system and has no concept of controlled high humidity. This is why some coatings such as that disclosed in WO 2019/073210 (Surrey NanoSystems Ltd) may give an acceptable SAE J1756 fog number and delta-haze after prolonged baking but give a poor one in humid heat trials such as at 85° C. and 90% RH over a 7-day period.

Cars are used across the world from dry desert areas to hot and highly humid tropical environments, so it is not feasible for an automotive manufacturer to choose a light absorbing coating that works only in a specific location but that degrades in another. The coating must work reliably in all environmental conditions found on earth where cars are used.

Other attributes that are preferred for this type of coating are: the ability to withstand large temperature swings as found in the tropics and polar regions, no degradation (change in blackness, cracking or delamination) from exposure to ultraviolet light, resistance to condensing water and no damage from frost formation, no generation of particulates through vibration/shock or general coating breakdown through the life of the car, and the ability to be applied through automated spray techniques to injection moulded polymer substrates that glareshields are typically manufactured from without the use of a primer coating. Plastic primer coatings have the same problem of fogging as the top light absorbing layers we have been describing.

### CURRENT STATE OF THE ART

WO 2017/033027 (Surrey NanoSystems Ltd) discloses a spray applied coating that meets many of the criteria required for a successful shield coating as it has a THR of 0.2% and good environmental stability, but it is limited in the following areas: It requires high temperature plasma processing (280° C.) in dedicated vacuum plasma reactors, it cannot be touched after manufacture as the optical structure is damaged easily, is costly to manufacture and contains carbon nanotubes which are prohibited in many automotive parts if directly exposed to drivers such as on glareshields that are mounted inside the driver cabin.

WO 2019/073210 (Surrey NanoSystems Ltd), discloses a spray applied coating with a THR in the order of 1% in the visible spectrum that can be prepared using an ordinary pigment (such as a carbon black based pigment that does not contain carbon nanotubes). To achieve a fogging number above 90 the coating must be baked for 3-5 hours at an extended temperature of 120° C. This adds significant production costs through additional hardware (baking ovens), loading and storage space.

Even after baking there is still hydrolytic degradation of the coating in humid environments leading to fogging. This is due to binder hydrolytic degradation and the functional groups on the carbon pigment used to stabilise the wet paint. Although the coating achieves a dry heat delta haze of 1.2%-1.5% after baking, the hydrolytic degradation will cause this to increase to unacceptable levels over the life of the car. The coating also has poor handling properties leading to low yield on automotive production lines through physical contact damage with the surface.

Although the coating does not suffer from UV degradation, the THR increases significantly to 1.2% after baking due to refractive index changes/oxidation on the base polymer and structural relaxation of the coating causing a change in the size of the porosity used to trap light. Whilst the performance of this coating is seen as best in class, it will not be suitable for more critical shield applications because of the humid heat fogging generated and its challenging handling due to the physically weak nature of the coating.

It also requires a high number of spray passes to build up the porous structure. Depending on the shape of the part to be coated, this can require up to 24 passes of the spray gun. This means it takes far longer to spray the component than with a conventional black paint that needs only 2-3 passes. Whilst this is tolerable because of the excellent THR, the automotive industry is cost and throughput sensitive so long cycle times have a negative impact on product use making it uneconomical for many OEMs.

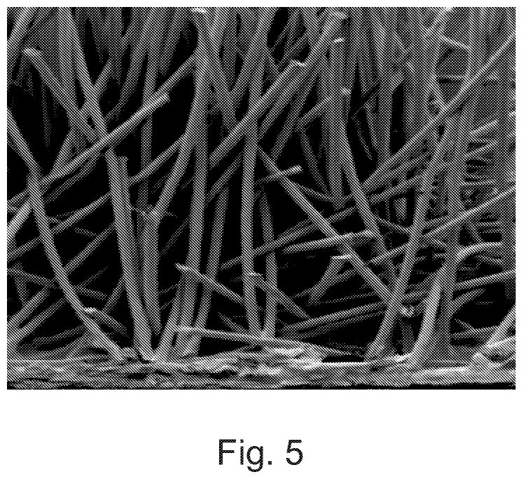

Flocking is well known a method used to create a black light absorbing surface on camera shields and lens hoods used with DSLR cameras. The best black flocks generally have a THR between 1-1.5% in the visible spectrum. Flock uses a base coating of glue that is then coated with electrostatically charged black fibres that partially align to create a velvet like light absorbing surface (see FIG. 5). The base glue and flock fibres are polymeric and so contribute significantly to fogging. They also suffer from UV degradation, colour fading and fibre release as not all fibres are firmly anchored in the glue during manufacture. As the coating is not conductive it suffers from static charge build-up which causes released fibres to migrate and attach electrostatically to the windshield glass and to the cameras and their polymer lenses. Because the fibres are shiny black polymer filaments, the flock tends to sparkle in the sunlight causing image degradation for some sun positions. Attempts have been made to reduce the fogging behaviour of flocks by baking at high temperature for many hours, but this has demonstrated only a small improvement in fog numbers, and the delta haze value remains above 2 for even the most expensive glues and fibres. The additional 12-16 hr bake to reach a delta haze above 2 also adds very significant per part costs in a volume automotive production environment. In hot humid environments, the delta haze increases to over 5 due to glue and fibre hydrolytic degradation.

Traditional black paints are also used in many camera shield systems. These are typically combinations of black metal oxide or carbon-based pigments and binder made through conventional paint formulation methods that have been known for generations. Because these are conventional solid black paints, their THR tends to be between 3%-12%, and they have poor angular trapping performance because they are fully dense with no porosity due to the pigment being fully encapsulated by the binder after drying. As these types of coatings have no porosity the coating reflection increases significantly as the photon arrival angle (AOI) decreases. They generally give poor optical performance for most sun positions so are combined with moulded ridges or baffles in the shield as an attempt to improve shield performance. This works for conventional ADAS 0 or 1 shields but is not successful for more advanced autonomous systems. As they contain significant amounts of functionalised pigments, binders and additives, they also fog severely in both dry and humid heat over the life of the car, with a typical extended SAE fog number in the 70s. Manufacturers have used additional processing steps of post spray baking to try to remove volatiles but this does not prevent hydrolytic breakdown of the binders and additives that remain after baking, and the baking process usually requires a temperature that distorts the shape of the injection moulded plastic part being coated when its undertaken for many hours. Another unwanted impact from baking conventional black paints for prolonged periods is increasing THR due to thermal oxidation of the binders as they move from transparent to milky yellow colours causing a more difficult path for the photon to reach the pigment. As the performance of ADAS cameras becomes more critical to driver and pedestrian safety, conventional black paints no longer offer a suitable solution.

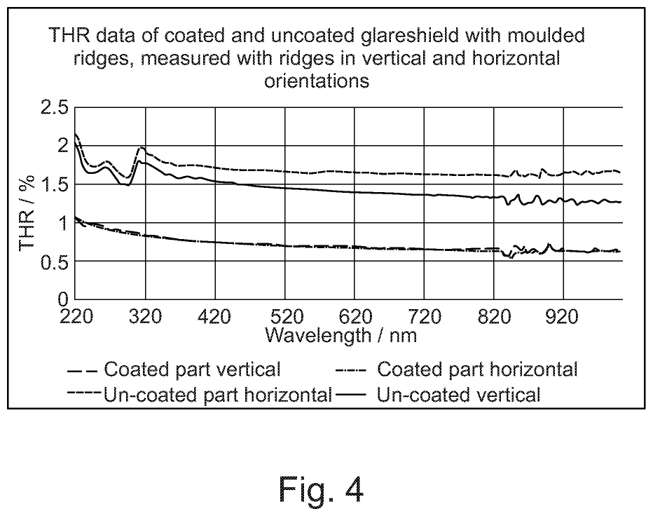

Some shield manufacturers also try to resolve the stray light challenge without the use of black absorbing paints by incorporating complex sawtooth baffle ridges in the shield moulding to direct the sunlight away from the camera. This resolves the problem of coating application and breakdown but cannot achieve a suitably low THR unless coated with the product of this invention (see FIG. 4 which relates to the coating of Example 6 below). Sawtooth ridges tend to only perform well for sun positions in the direction of the ridges and poorly when the sun position is shining across them. Because of the change in design to wider field of view cameras and shields, and having multiple cameras in the same shield, this method is no longer successful so is generally not being used for more safety critical wide field of view or multi camera ADAS 2+ shields. It should also be noted that the best THRs that can be obtained with sawtooth ridged glareshields are still not capable of passing the stringent safety and performance requirements set by the ADAS level 2+ control system manufacturers.

As disclosed in WO 2019/073210 (Surrey NanoSystems Ltd), a spray applied coating with a THR in the order of 1% in the visible spectrum can be prepared using an ordinary pigment (such as a carbon black based pigment). This patent demonstrated for the first time that a conventional black amorphous carbon pigment could be used to trap light uniformly and efficiently across a wide range of arrival angles by forming a highly porous pigment binder structure, but the invention had no concept of low fogging. Traditional black paints had always embedded and surrounded the black pigment with the binder in a solid structure giving the coating strength and durability, but this results in a poor THR and angular performance. By adding high levels of porosity to the coating a higher surface area was created for photons to enter and go through multiple bounces in the porous cavities until absorbed by the pigment. The increased porosity led to higher surface roughness, and this roughness, when combined with the porosity, allowed for photons to be trapped more efficiently than conventional paints, and from any photon arrival angle. The coating developed had a low THR and TIS but was very weak in physical contact and had no abrasion resistance, and under humid heat conditions the coating would fog. This fogging was due to the functionality on the carbon pigment and from hydrolytic breakdown of the binder system that had to be used to create a stable liquid paint with a good shelf life. Baking the coating reduced this thermal fogging but could not prevent humid heat fogging due to the nature of the pigment functionality and binders used.

CN113201272A (SHANXI HUABAO NEW MAT CO LTD et al.) discloses a multicolor low-gloss water-based paint primer-finish paint composition for a passenger train. The multicolor low-gloss water-based paint primer-finish paint composition comprises a water-based acrylic polyurethane finish and a water-based epoxy primer, wherein the water-based acrylic polyurethane finish adopts hydroxyl-containing water-based acrylic resin, self-extinction water-based polyurethane resin and a hydrophilic polyisocyanate curing agent as film-forming substances and employs pigment and water-based organic color paste to compositely adjust the color of the paint; and the waterborne epoxy primer provides adhesive force with a metal substrate.

WO9616109A1 (AMERON INC) discloses a sprayable, trowelable epoxy polysiloxane based coating and flooring composition exhibiting excellent weatherability in sunlight and superior chemical, corrosion and impact resistance after curing is made up of: (a) a resin component which includes a non-aromatic epoxy resin having at least two 1,2-epoxy groups per molecule; a polysiloxane and an organooxysilane; (b) an amine hardener component substituted in part or in whole by an aminosilane; (c) an organotin catalyst; and (d) an aggregate or pigment component.

CN109852334A (JIANGSU CREVO SCIENCE & TECH CO LTD) discloses a settling resistant dual component organic silicon casting glue, which comprises a component A and a component B according to a mass ratio of 12-14:1. The component A comprises following components in parts by weight: 100 parts of alpha, omega-dihydroxyl polydimethylsiloxane, 100 to 200 parts of a filling material, 1 to 20 parts of a plasticizer, 0.5 to 5 parts of a water remover, 0.5 to 4 parts of a fluid rheology aid, and 0 to 10 parts of a pigment. The component B comprises following components in parts by weight: 100 parts of a curing agent carrier, 40 to 60 parts of a silane crosslinking agent, 10 to 20 parts of a silane coupling binding promoter, and 0.05 to 1 part of a catalyst. The liquid rheology aid is a dimethyl sulfoxide solution of a modified urea rheology aid. The weight percentage concentration of the dimethyl sulfoxide solution is 30 to 85%.

It is desired to produce a coating having a low light reflectivity and low fogging.

### SUMMARY OF THE INVENTION

In accordance with a first aspect of the invention, there is provided a method of coating a substrate to form a light absorbing, non-transparent film, including the steps of:
(a) providing a suspension in a solvent of:
   (i) a pigment,
   (ii) a binder which includes a polymer with hydrolysable functional groups (preferably a polysiloxane, a polyol, or a combination thereof),
   (iii) a rheology modifier, and
   (iv) an adhesion promoter which includes a silane group;

(b) spray-coating the suspension onto the substrate with the majority of the solvent evaporating before the suspension contacts the substrate in order to result in a porous coating;

(c) repeating step (b) until the average coating thickness is at least 20 micrometres; and

(d) curing the coating in order to result in a delta-haze of less than 1 (measured to ASTM-D1003-21 through glass) and a fog number of at least 95 fog numbers as measured by an extended SAE-J1756 photometric test at 120° C. for 168 hrs with a 21° C. collector plate temperature.

The present applicant has developed a new method for creating a spray applied super-black absorber paint that is stable over long periods of storage including the temperatures found in container shipping that crosses the equatorial regions, that has exceptionally low fogging, low delta haze, is thermally stable, has no breakdown from UV exposure, good handling and can be spray applied to polymer, composite or metallic glareshields.

In a preferred embodiment the pigment is carbon black based or is a mineral based black such as spinel black, black titania, iron oxide, manganese oxide, mixed metal oxides. It preferably has a non-spherical branched structure and most preferably does not have any added functional groups through oxidation or chemical grafting.

The rheology modifier is preferably a polyol, optionally including polar and non-polar groups (such as an acrylate polyol). As the preferred binder may include a polyol, in some embodiments a single type of polyol can be provided that has the dual role of being a co-binder (for example with a polysiloxane) and a rheology modifier.

The ratio of solvent to binder is preferably from 1:0.6 to 1:1.15, and most preferably is about 1:0.88.

The ratio of pigment to binder in step (a) is preferably from 1:8 to 1:4, most preferably about 1:5.6.

The evaporation of solvent in step (b) may be controlled such that the resulting coating has pores which range in diameter from 100 nm to 100,000 nm.

The coating of step (c) preferably has a dry film density range of up to 1.3 gcm⁻³, most preferably from 0.3 to 0.8 gcm⁻³.

A dispersant may be provided which is preferably a non-ionic dispersant, and most preferably includes hydroxyl functionality which enables the dispersant to be covalently bonded in cross-linked systems.

We have found that we can make a stable paint system suitable for automotive plastics preferably based on methyl polysiloxane binders, a catalyst, a highly volatile solvent and a carbon-based pigment with a highly branched structures (≥OAN of 175 ml/100 g) and no additional functionalisation on the pigment, and by adding in a polyol that acts as a rheology modifier so allowing a stable paint dispersion to be created that flows through the spray gun without blockage and without the need of adding traditional additives that would contribute to fogging. It has been found that any additives that have to be used should ideally be chemically bound or crosslinked into the dry film so there can be no interaction with humid heat to generate fog.

A number of preferred embodiments will now be described with reference to the drawings, in which:

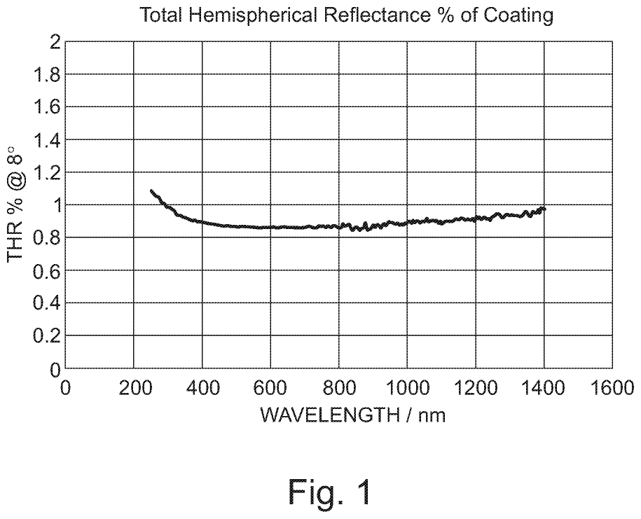

FIG. 1 is a graph showing the total hemispherical reflectance (THR) from UV to near infrared for the coating of Example 6 in accordance with the invention;

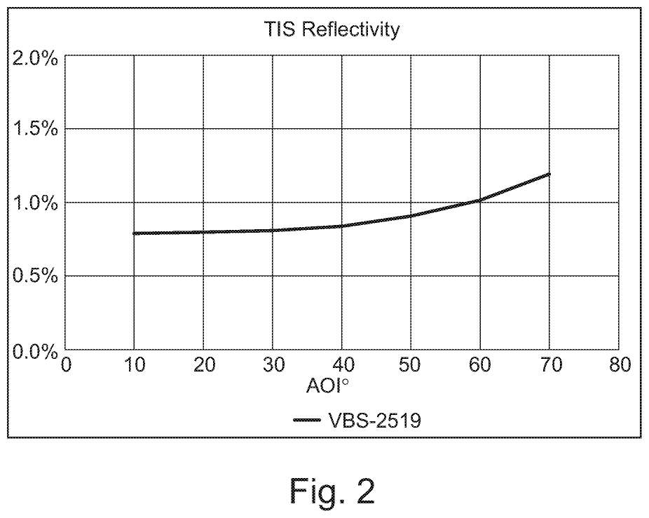

FIG. 2 is a graph of the total integrated scatter measured against the angle of incidence using a white light illumination source for the coating of Example 6;

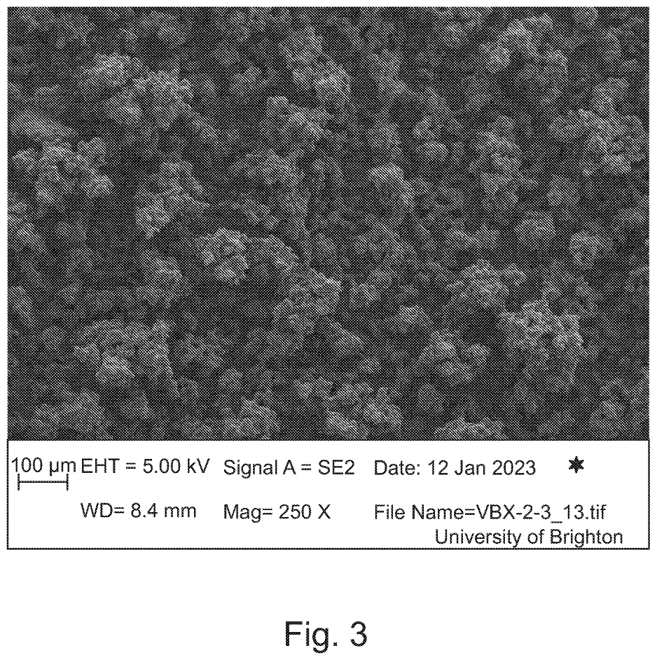

FIG. 3 is a scanning electron microscope image (SEM) of the sprayed and cured coating of Example 6 showing its optical structure and porosity;

FIG. 4 is a graph showing THRF as a function of wavelength for a coated and uncoated glareshield (for the coating of Example 6); and

FIG. 5 is an SEM showing a flocked surface.

### MEASURING OPTICAL PERFORMANCE

In order to understand how a black absorber coating performs optically we measure the total hemispherical reflectance (THR) as this is the most complete measurement of reflectance and is the accepted global standard for measuring the performance of very low reflectivity materials. It should not be confused with the general term ‘reflectance’ as this can be misleading e.g., a piece of sawn wood has a low specular reflectance, but it is obviously not black. Other optical methods that are key to measuring an absorber coating performance are BRDF (bidirectional reflectance distribution function) and TIS (total integrated scatter). These tests demonstrate how light scatters from a surface for different photon arrival angles and detector positions. Optically, the most desirable properties for a shield coating would be for it to have a low THR<1% and a low total integrated scatter and BRDF. If these properties can be created with a material that has the underlying functional properties previously mentioned, is low cost and can be applied through conventional spray application, then the coating would be suitable for ADAS camera system stray light protection to the point where all cars are fully autonomous.

To measure THR an integrating sphere, internally coated with a highly reflective surface (such as barium sulphate BaSO4) is used to a collect light reflected off a sample from all angles. The amount of light reflected from a sample is compared to that reflected by a diffuse BaSO4 reference as a percentage. The incident light is focused at 8 degrees off normal so that specular as well as diffuse contributions from the surface are collected. Typical state of the art black pigment absorber coatings manufactured through conventional means have THRs in the range of 3%-10%, so are not able to improve the performance of optical systems beyond what has already been achieved, and as mentioned previously, the binder/pigment systems are prone to significant fogging making them unsuitable for long term advanced ADAS stray light protection.

Preferred embodiments of the present invention provide an improved method of coating a substrate (for example a stray light automotive glareshield) with a coating that satisfies the requirement to have a very low THR (<1%), low delta haze (<0.8%) after an extended fog trial and exposure to 85° C. at 90% RH for at least 14 days, an extended high temperature fog number of >98, thermal stability from −70° C. to 180° C., UV fade resistance, and can be applied through conventional means and at an economic cost to moulded polymer substrates without a primer layer so making it viable in automotive production.

Preferred components of the method are described below.

### Binder

A preferred binder is SILRES® MSE 100 (Wacker) which is a methoxyfunctional methyl polysiloxane binder that is possible to cure at low temperature through means of a catalyst. It has a low refractive index and does not oxidize within the temperature range specified for the coating so the THR will not change over the life of the car. Once fully crosslinked polysiloxane binders produce a very stable material that is not impacted by humid or dry heat of the type that is found in automotive environments (humidity benefits the curing process). They would seem to be ideal, but other moisture resistant crosslinkable binders such as polyols, though less desirable, may also be selected as long as the rest of the steps are followed, and they can be made compatible with highly volatile solvents for spraying.

Preferred polyol binders include:
Polyether polyol
Polyester polyol
Silicone glycol
Polyolefin polyol
Castor oil polyol
Hydrogenated castor oil polyol
Acrylic polyol
Phenol-based polyol
Polyethylene polyol
Polypropylene polyol
Polytetramethylene ether glycol.
Polyethylene glycol adipate
Polycaprolactone polyol
Polycarbonate polyol
Caprolactone-modified polycarbonate diol
Caprolactone-modified acrylic polyol
Silicone glycols
Polybutadiene polyol, hydrogenated polybutadiene polyol
Polyether polyol

A particularly preferred polyol binder is SETALUX® 1184 SS-51 (Allnex).

Binders that are UV crosslinked and cured are also a potential solution as crosslinking makes them stable to heat and moisture, but we found when these are used in porous light absorbing paints the UV light used to cure the binder fails to penetrate through the full depth of the coating leading to a partially cured layer that fogs badly in dry and humid heat.

### Pigment

To make a stable paint solution we used a highly branched amorphous carbon pigment with no additional functionality, namely Printex Kappa 50 (previously called XPB 545 and produced by Orion Engineered Carbon). It has been found that traditional metal oxide or amorphous carbon pigments tend to form very low viscosity liquids with methyl polysiloxane binders and if there is no pigment functionality then the pigment drops rapidly out of solution after mixing unless significant levels of dispersants are used.

The branched structure pigment used in this invention allowed for partial stability in the methyl polysiloxane binder due to its high surface area and enhanced structure through pigment particles being able to physically interact with each other in solution. This allowed us to create a partially stable solution, but it was too difficult to spray due to its low viscosity, and the pigment would still drop out of solution and sediment over a few days.

Carbon black particles clump together to form aggregates. Structure is a measure of the shape and degree of branching of the aggregates. It can be measured by oil absorption analysis (the OAN figure referred to above). The high structure of the preferred pigment used results in easier dispersibility due to the branched structure of the particles. The high structure also provides a thickening effect which benefits the paint stability as traditional carbon black pigments tend to form a very low viscosity paints with methyl polysiloxanes where the pigment rapidly drops out of solution after mixing unless traditional stabilisers are used. Lastly, the high surface area and branched structure of the pigment allows for good jetness (that is, a measure of the blackness) and film cohesion as the branched structures allow interconnectivity with each other whilst not impeding the formation of film porosity during the spray application step.

### Dispersant

The traditional route to resolve wet paint stability is to use surfactants or dispersants so we investigated multiple dispersing agents to try to stabilise the solution. They worked well at the manufacturers recommended levels, but as expected, they all caused the dry paint samples to severely fog to unacceptable levels and caused upward and unacceptable shifts in THR. Paint dispersants are typically used at a rate of 40%-100% of the weight of the pigment, but a highly branched structure may require more. We found putting in dispersants at this level caused very significant fogging regardless of the type tested, even when we attempted to crosslink them in chemically.

It was surprisingly discovered that the paint solution could be stabilised with Borchi® Gen DFN (Borchers) as a non-ionic dispersant with hydroxyl functionality that would chemically bond and crosslink into the dry film when used at low percentages such as at 4% of the pigment mass. When used at higher levels the coating would start to fog.

### Coating Structure

To provide efficient absorption from all angles (0-90°), the low-density structure needs to have a surface texture that scatters the light away that fails to enter into the coating porosity. This diffuse surface roughness or structure should be created whilst applying the coating. A measurement of the absorber coating's ability to absorb and scatter light from different AOI is called TIS, or total integrated scatter. A surface that is strongly absorbing when seen direct on almost always increases in THR when viewed beyond 45° angle of incidence (see FIG. 2 which shows the coating of Example 6 TIS measured against the angle of incidence in accordance with the invention), but the surface structure and porosity showed only minimal change even out to 70° AOI (limit of the measuring system) confirming that the structure formed offers exceptional angular performance over conventional black paints and flocking.

There are multiple factors which effect the density and surface topography of the coating, such as distance of spray nozzle to surface, type of nozzle, ambient temperature, humidity, temperature of substrate etc. We have discovered that the rate at which the solvent evaporates from the coating composition (either in flight or rapidly after it has contacted the surface) is particularly important. The person skilled in the art (such as a spray technician) will be able to adjust these spray factors in order to prepare a coating of the preferred density.

During the spray application process there are several parameters which can guide the technician to knowing that the correct result has been achieved. The ideal area density of the coating (if the substrate is practically weighed) should be between 4-10 mg cm⁻². The volume of paint to achieve this density is between 0.025 and 0.05 mL cm⁻² depending on transfer efficiency and overspray. Once sufficient volume has been sprayed the parts are inspected under a bright wide spectrum white light next to a standard sample of known THR values. The level of apparent blackness should be indecipherable from all angles and the level of roughness compared. No pinholes or non-uniformities should be apparent. If the target being sprayed appears less black and smoother, more paint may be applied in order to achieve the target roughness whereby particles are clearly evident on the surface under a bright wide spectrum torch. Where a non-uniform surface is apparent with both grey areas and a rough surface, it suggests that the paint has been applied too wet rendering a smooth underlayer with a rough surface.

### Coating Thickness

It should be noted that traditional paints manufactured with methyl polysiloxanes typically have their applied thickness limited to about 20 microns and are wet sprayed to form solid films to ensure they bond to the metal substrate being coated. Above this thickness they can stress delaminate on heating from typical metal substrates and this would not be acceptable in our application. For plastic substrates the delamination issue is worse as the surface energy of the polymer substrate is much lower than that of a metal causing the sprayed film to have poorer adhesion. Unless the film chemically bonds to the surface, stress delamination will be more severe on polymer substrates. For our coating to have a low THR we need to form a porous coating with a thickness above 20 microns, so this was a challenge we had to resolve.

We found that adding a polyol to the methyl polysiloxane and a low percentage of a crosslinkable dispersant we would remove the inherent stress from the film, allow the material to spray correctly, and make the paint solution stable over long periods. Note that it may also be possible to create the film by using a polyol without the methyl polysiloxane if all other steps are followed. We also added an alkoxy silane to act as a water scavenger as methyl polysiloxanes are highly sensitive to humidity in long term storage as moisture can initiate polymerisation of the binder. The alkoxy silane also known to have an added benefit of enhancing adhesion to low surface energy substrates and will fully crosslink into the resin system so does not contribute to fogging.

Although the addition of the polyol resolved the film stress and stability it caused challenges related to curing the sprayed film. Polyols are typically cured with isocyanate agents, and if not fully cured correctly, the uncured polyol fragments are reactive with humid heat to create fogging. Isocyanate curing also limits paint pot life as the reaction starts as soon as it is added to the paint solution. For this reason, isocyanate catalysts were not seen as acceptable so were discounted for this application on polymer substrates.

### Catalyst

A titanium butoxide catalyst may be used to cure the methyl polysiloxane and works by exchanging the alkoxide functional groups resulting in hydrolysis. The hydrolysed species can then undergo polycondensation to form a crosslinked structure. The titanium butoxide catalyst can be used to exchange alkoxide groups on other species containing alkoxide groups as well as the methyl polysiloxane. Titanium butoxide can also be used to catalyse acetoxy exchange of other acetoxy functional species.

The acrylic polyol we used is composed of acrylic acid or alkyl ester group, as well as a polyol functionality. As mentioned above, the polyol functionality is usually the cross-linkable species when using isocyanate cross-linkers. During development it was theorized that the polyol functionality could participate in the polycondensation with hydrolysed methyl polysiloxane. Evidence also suggests that the acrylic acid or alkyl ester groups were able to undergo acetoxy exchange using the titanium butoxide catalyst. This provides a secondary species which may then undergo polycondensation with the hydrolysed methyl polysiloxane leading to a fully crosslinked and thermally stable modified binder system that would be free from fogging.

The experimental results demonstrated that this was the case in that we created a spray applied coating, cured at low temperature, with all the desirable functional benefits for the ADAS application disclosed.

### Porosity

Once you can create the stable paint that will not fog after application and curing you should create porosity and the preferred optical structure to trap light during the spray application step, so it has a THR below 1% in the visible spectrum.

The amount of light reflected from a surface under normal incidence is proportional to the difference in refractive index of the materials at the interface in accordance with Fresnel's equation. Therefore, the more similar the refractive index of the materials (air and the coating) the closer to zero the reflectance will tend to be. For a particular material, the refractive index will decrease as the density is reduced and so a drop in reflectance will be observed.

### Solvent

To create the low-density structure, you may use a highly volatile solvent that flash evaporates during the spray process as the paint leaves the gun, so the solvent does not pool or build up in the sprayed film. If the solvent used doesn't flash evaporate, then the coating will arrive too wet and minimal porosity will be produced leading to a higher THR that is typical of conventional black paints. One potential route to use a less volatile solvent is to heat the substrate to a temperature sufficient to rapidly evaporate the solvent from the binder/pigment mix and delay each spray pass to make sure the solvent from the prior pass has gone. This is obviously not ideal as it would significantly increase the time to coat a part and having heaters in an environment where you are spraying solvents that evaporate and build up would be costly due to the fire risk. The only benefit of a high boiling point solvent would be the reduced shipping cost by air or sea freight and a simpler spray booth system.

Most polymers used in paint manufacture today are based on aqueous systems or stable VOC based solvents like xylene and toluene that are designed to slowly evaporate in a controlled manner to produce a dense, hard coating. When you try to create a spray paint system from highly volatile solvents such as acetone, traditional binders and additives tend not to create a stable solution without significant percentages of unwanted stabilising additives being incorporated (as discussed above). If you do succeed in creating a stable paint, when you try to spray it the rapid solvent evaporation usually blocks the spray gun nozzle, and the additives cause it to fog severely under humid heat as they are not chemically locked into the binders. The challenge is finding a binder, pigment and volatile solvent combination that can be fully crosslinked after spraying, is stable after manufacture, that can be sprayed consistently, deliver porosity through flash solvent evaporation and the correct THR whilst having all the underlying functional properties needed in a glareshield application.

### Rheology Modifier

When we added the polymer pigment dispersion to a highly volatile solvent like acetone, we found it remained unstable unless rheology modifiers were used but the traditional ones generated high levels of fog during trials, so we looked for other possible solutions. Literature has shown that binders like PVAc have been used as stabilisers in some traditional paint formulations, but we know from trials that PVAc suffers serious degradation under humid heat conditions, so after a number of tests with binders that could act as a rheology modifier we realised that we could stabilise the paint by using an acrylic polyol that could be crosslinked into the film through the use of the titanium butoxide catalyst that cures the methyl siloxane binder. The polyol can also have a dual role as a co-binder.

This modified binder combination when combined with acetone and a branched carbon pigment structure allowed us to create a low THR stable paint solution without components that would create fog under thermal and humid heat conditions found in ADAS applications. The acetone allowed us to spray the substrate with multiple passes using a spray technique that allowed most of the solvent to evaporate before the binder and pigment combination reached the substrate. Using this spray method, we were able to build up a highly efficient porous structure with as little as 3 spray passes and the structure had good handling properties.

The porous structure of the coating of Example 6 (see FIG. 3) is created through the spray application process when the optimum solvent/binder/pigment combination passes through the spray gun nozzle. The fan gas rapidly atomises the paint into small droplets with a wide range of wet droplet sizes whilst the majority of the solvent, due to its volatility, evaporates before the paint reaches the substrate to be coated. As the solvent rapidly evaporates, the droplets are primarily binder and pigment and due to the rapidly decreasing solvent content, are viscous and incapable of forming a dense wet film as they arrive at the surface, but they are capable of sticking to each other. With each spray pass you form little islands of pigment and binder that start to build a coral reef like optical structure with pores and surface roughness that is excellent for trapping photons. It should be noted that the transit distance of the spray process will have a large impact on the optical structure formed. Spraying too close will not allow enough of the solvent to evaporate causing a higher density and higher THR film to form, but spraying to far will allow too much solvent to evaporate and the pigment binder combination to dry too much before hitting the surface causing the coating to be dusty and with little cohesion.

By the addition of a titanium butoxide catalyst to cure the coating and through the use of an unfunctionalized branch structured pigment we were able to make an extremely resilient coating that had exceptional properties for use in ADAS stray light control, one that would bond easily to polymeric injection moulded parts without an additional undercoat, and importantly, be able to cure without the need for high temperature, prolonged baking that is typically required where silicone binders are used without a catalyst. This is important as non-catalysed curing temperatures would severely damage plastic injection moulded shields.

It should be noted that the by-products of curing by the titanium butoxide catalyst and humidity are water, titanium dioxide, butanol and methanol. To achieve the highest fog numbers, the cured part should go for a rapid, but low temperature bake (30 min at 80° C. in air) to remove all traces of volatile cure by products. The catalyst converts to nanoscale titanium dioxide which is completely stable and has no impact on the coating optical properties.

The viscosity of the paint formulation is preferably adjusted by modifying the solvent ratio to achieve a viscosity of the freshly prepared paint of between 2000-6000 cps (Brookfield method).

The ideal solvent ratio can depend on many things such as binder-solvent interactions, pigment particle size and surface area so solvent may be increased or decreased to achieve the correct viscosity to atomise and deliver the paint in the correct way to ensure partial drying of the solution prior to arrival at the substrate.

### EXPERIMENTAL

### Measuring Total Hemispherical Reflectance (THR), Fogging and Delta-Haze

We measure Total Hemispherical Reflectance by using a Shimadzu UV-NIR 2500 Spectrometer fitted with a barium sulphate integrating sphere. The test sample is placed on the measurement port on the integrating sphere and exposed to the illuminating source. A detector collects the reflected energy from the sample coating and plots the performance from 200 nm to 1400 nm. Prior to any measurement being taken the instrument is calibrated against a known reflectance standard.

Fogging tests were run on a: Thermo Fisher Scientific Horizon Fog testing system

Delta haze tests were measured on a: BYK Haze-Guard system

### Coating Examples

### SUMMARY

Examples 1-2 cover a paint using SILRES® MSE 100 (a methoxyfunctional methyl polysiloxane produced by Wacker) and SETALUX® 1184 SS-51 (an acrylic polyol with 2.0% OH produced by Allnex) as the binders and Printex Kappa 50 (Orion Engineered Carbon) as the pigment, with a pigment to binder ratio (PTB) of 1:5.5 in acetone as the solvent. The paint also contains GENIOSIL® XL 10 (Wacker) as an adhesion promoter; and Borchi® Gen DFN (Borchers) as a non-ionic dispersant.

Example 3 covers a paint using SILRES® MSE 100 (Wacker) and SETALUX® 1184 SS-51 (Allnex) as the binders and Printex Kappa 50 (Orion Engineered Carbon) as the pigment, with a pigment to binder ratio (PTB) of 1:6.2 in acetone as the solvent. The paint also contains GENIOSIL® XL 10 (Wacker) as an adhesion promoter; and Borchi® Gen DFN (Borchers) as a non-ionic dispersant.

Example 4 covers a paint using SILRES® MSE 100 (Wacker) as the binder and Printex Kappa 50 (Orion Engineered Carbon) as the pigment, with a pigment to binder ratio (PTB) of 1:2.1 in acetone as the solvent.

Example 5-6 cover a paint using SILRES® MSE 100 (Wacker) and SETALUX® 1184 SS-51 (Allnex) as the binders and Printex Kappa 50 (Orion Engineered Carbon) as the pigment, with a pigment to binder ratio (PTB) of 1:6.2 in acetone as the solvent. The paint also contains GENIOSIL® XL 10 (Wacker) as an adhesion promoter; and Borchi® Gen DFN (Borchers) as a non-ionic dispersant. Example 6 contains a 2.4% catalyst loading, double the catalyst loading of example 5, which has 1.2%.

Examples 1-6 also all contain titanium (IV) butoxide as the catalyst.

Example 8 covers a paint made using an iron oxide black pigment instead of carbon black. Similar to examples 1-6 the paint contains SILRES® MSE 100 (Wacker) and SETALUX® 1184 SS-51 (Allnex) as the binders, GENIOSIL® XL 10 (Wacker) as an adhesion promoter; and Borchi® Gen DFN (Borchers) as a non-ionic dispersant.

The following Table summarizes the quantities of materials used in Examples 1-6 and 8.

TABLE 1

| | Component | | | | | | | | | Pigment | Cat. |
|---|---|---|---|---|---|---|---|---|---|---|---|
| Example | units | Acetone | Silres | Setalux | Geniosil | Pigment | Dispersant | Total | PtB | loading | Loading |
| 1 | mass/g | 350 | 261 | 48 | 37 | 55 | 11 | 780 | 1/5.5 | 7.1% | 2.40% |
| | percentage/% | 44.9 | 33.5 | 6.2 | 4.7 | 7.1 | 1.4 | 100 | — | — | — |
| 2 | mass/g | 350 | 261 | 48 | 37 | 55 | 11 | 775 | 1/5.5 | 7.1% | 1.70% |
| | percentage/% | 45.2 | 33.7 | 6.2 | 4.8 | 7.1 | 1.4 | 100 | — | — | — |
| 3 | mass/g | 9080 | 6770 | 1250 | 960 | 1280 | 60 | 19467 | 1/6.2 | 6.6% | 2.40% |
| | percentage/% | 46.6 | 34.8 | 6.4 | 4.9 | 6.6 | 0.3 | 100 | — | — | — |
| 4 | mass/g | 510 | 287 | — | — | 139 | — | 942 | 1/2.1 | 14.8% | 2.40% |
| | percentage/% | 54.2 | 30.5 | — | — | 14.8 | — | 100 | — | — | — |
| 5 | mass/g | 9080 | 6770 | 1250 | 960 | 1280 | 60 | 19637 | 1/6.2 | 6.5% | 2.40% |
| | percentage/% | 46.2 | 34.5 | 6.4 | 4.9 | 6.5 | 0.3 | 100 | — | — | — |
| 6 | mass/g | 9080 | 6770 | 1250 | 960 | 1280 | 60 | 19874 | 1/6.2 | 6.4% | 2.40% |
| | percentage/% | 45.7 | 34.1 | 6.3 | 4.8 | 6.4 | 0.3 | 100 | — | — | — |
| 8 | mass/g | 350 | 261 | 48 | 37 | 55 | 2.41 | 751 | 1/6 | 7.3% | |
| | percentage/% | 46.6% | 34.8% | 6.4% | 4.9% | 7.3% | 0.3% | — | — | — | — |

Example 7 describes a 2-component ethyl acetate based polyurethane paint, using SETALUX® 1184 SS-51 (Allnex) as a binder; Solsperse M387 (Lubrizol) as a dispersant; and Tolonate HDB 75 MX as an isocyanate crosslinker. Table 2 contains the quantities of materials used in this formulation.

TABLE 2

| | Component | Ethyl | | | | | | Pigment | Isocyanate |
|---|---|---|---|---|---|---|---|---|---|
| Example | units | Acetate | Setalux | M387 | Pigment | Total | PtB | loading | loading |
| 7 | mass/g | 271 | 167 | 6 | 150 | 594 | 01:01.1 | 25.30% | 5.30% |
| | percentage/ | 45.6 | 28.1 | 1 | 25.3 | — | — | — | — |
| | % | | | | | | | | |

Example 9 describes a paint using SILRES® MSE 100 (Wacker) and Zeffle GK (Dakin) as the binders and Printex Kappa 50 (Orion Engineered Carbon) as the pigment, with a pigment to binder ratio (PTB) of 1:6.2 in acetone as the solvent. The paint also contains GENIOSIL® XL 10 (Wacker) as an adhesion promoter; and Borchi® Gen DFN (Borchers) as a non-ionic crosslinkable dispersant. Table 3 contains the quantities of materials used in this formulation.

TABLE 3

| | Component | | | | | | | | | Pigment | Cat. |
|---|---|---|---|---|---|---|---|---|---|---|---|
| Example | units | Acetone | Silres | Zeffle | Geniosil | Pigment | Dispersant | Total | PtB | loading | Loading |
| 9 | mass/g | 9080 | 6770 | 1250 | 960 | 1280 | 60 | 19467 | 1:6.2 | 6.6% | 2.40% |
| | percentage/% | 46.6 | 34.8 | 6.4 | 4.9 | 6.6 | 0.3 | 100 | — | — | — |

Example 10 describes a paint using Macrynal SM 6826w/43WA (Allnex) as the binder and FW171 (Orion Engineered Carbon) as the pigment, with a pigment to binder ratio (PTB) of 1:1.5 in water as the solvent. The paint also contains Borchi® Gen DFN (Borchers) as a non-ionic dispersant and Additol 6393 as the defoamer. Table 4 contains the quantities of materials used in this formulation.

TABLE 4

| | Component | | | | | | | | Pigment | Isocyanate |
|---|---|---|---|---|---|---|---|---|---|---|
| Example | units | Water | Macrynal | Pigment | Defoamer | Dispersant | Total | PtB | loading | Loading |
| 10 | mass/g | 516 | 116 | 75 | 0.49 | 18.75 | 726 | 1/1.5 | 10% | 4.20% |
| | percentage/ | 71.1% | 16.0% | 10.3% | 0.1% | 2.6% | 100.0% | — | — | — |
| | % | | | | | | | | | |

### Example 1: Higher Pigment Loading and Higher Catalyst Loading

A batch of binder; solvent; and additives was pre-mixed to the ratio 49.5:36.9:6.8:5.2:1.6 (w/w) acetone:SILRES® MSE 100:SETALUX® 1184 SS-51:GENIOSIL® XL 10:Borchi® Gen DFN using a homogenizer. Pigment was added to this mixture at a loading of 7.1% and mixed using a high shear mixer for 10 min at 7000 rpm to produce the 1 L batch of paint. Prior to spraying titanium (IV) butoxide was incorporated into the paint using a homogenizer, at a loading of 2.4 wt. %. The resulting paint was sprayed using a pressure-fed Devilbiss GTI Pro-lite spray gun fitted with 0.8 mm fluid tip and TE 40 air-cap. The spray settings were as follows: 1 bar fan pressure; 76 ml min⁻¹ flow rate; 0.5 bar fluid pressure; 15 cm target distance; 15 passes; and under typical atmospheric conditions. 3 bead-blasted aluminium coupons were sprayed, the coating was then cured for up to 16 hours at ambient temperatures, and then cured at 90° C. for up to 2 hours.

The resulting coating gave THR values ranging from 0.80-0.87% at 550 nm and 0.79-0.86% at 700 nm. The masses of the coating ranged from 80-100 mg, indicating an average mass of 6-8 mg cm⁻². The average coating thickness ranged from 163-209 μm. The fog number for this paint was found to be 98 under the following test conditions: (SAE J1756) 144 h at 120° C. This paint was suitable in terms of its fog number, THR and thickness. The paint's fogging, light-absorbing and coating-thickness properties were suitable for its application. However, the paint lacked homogeneity and was difficult to spray consistently so would not be suited for an automated production environment.

### Comparative Example 2: Lower Catalyst Loading

A batch of binder; solvent; and additives were pre-mixed to the ratio 49.5:36.9:6.8:5.2:1.6 (w/w) acetone:SILRES® MSE 100:SETALUX® 1184 SS-51:GENIOSIL® XL 10:Borchi® Gen DFN using a homogenizer. Pigment was added to this mixture at a loading of 7.1% and mixed using a high shear mixer for 10 min 7000 rpm to produce the 1 L batch of paint. Prior to spraying titanium (IV) butoxide was incorporated into the paint using a homogenizer at a loading of 1.7 wt. %. The resulting paint was sprayed using a gravity-fed Devilbiss Pro-lite S spray gun fitted with 1.2 mm fluid tip and TE10 air-cap. The spray settings were as follows: 1.25 bar fan pressure; 10-15 cm target distance; and under typical atmospheric conditions. Two bead blasted aluminium coupons were sprayed and gave THR values ranging from 0.86-0.90% at 550 nm of and 0.86-0.90% at 700 nm. The coating mass ranged from 99-128 mg indicating an average mass of 8.2-10.7 mg cm⁻². The average coating thickness ranged from 238-272 μm.

The fog number for this paint was found to be 94 under the following test conditions: (SAE J1756) 144 h at 120° C. This paint was suitable in terms of its THR and thickness. However, the fog number was too low and was found to be inconsistent between tests, for this reason this paint was ultimately unsuitable for its application. It is believed that the curing conditions resulted in this mix being unsuitable.

### Example 3: Decreased Pigment

A batch of binder, additives and solvent was pre-mixed to the ratio 50.1:37.4:6.9:5.3:0.3 (w/w) acetone:SILRES® MSE 100:SETALUX® 1184 SS-51:GENIOSIL® XL 10:Borchi® Gen DFN using a homogenizer. Pigment was added to this mixture at a loading of 6.6% and mixed using a high shear mixer for 27 min at 4500 rpm to produce the 20 L batch of paint. Prior to spraying titanium (IV) butoxide was incorporated into the paint using a homogenizer at a loading of 2.4 wt. %. The resulting paint was sprayed using a pressure-fed

Devilbiss GTI Pro-lite fitted with 0.8 fluid tip and TE40 air-cap. The spray settings were as follows: 1 bar fan pressure; 80 ml min⁻¹ flow rate; 0.5 bar fluid pressure; 15-20 cm target distance; and under typical atmospheric conditions. 3 bead blasted aluminium coupons were sprayed and gave THR values ranging from 0.79-0.89% at 550 nm and 0.79-0.89% at 770 nm. The coating mass ranged from 36-61 mg, indicating an average mass of 3.0-5.1 mg cm⁻². The average coating thickness ranged from 67-79 μm.

The fog number for this paint was found to be 97 under the following test conditions: (SAE J1756) 144 h at 120° C.

This paint was suitable in terms of its fog number, THR and thickness. The paint also showed good stability during storage; improved homogeneity; and sprayed well. For these reasons this paint was determined to be a most preferred paint.

### Comparative Example 4: No Additives

A batch of binder and solvent was pre-mixed to the ratio 5.4:3 (w/w) acetone:SILRES® MSE 100 using a homogenizer. Pigment was added to the mixture at a loading of 14.8% and mixed using a high shear mixer for 6 min at 7000 rpm to produce the 1 L batch of paint. Prior to spraying titanium (IV) butoxide was incorporated into the paint using a homogenizer with a loading of 2.4 wt. %. The resulting paint was sprayed using a gravity fed Devilbiss Pro-lite S fitted with 1.2 fluid tip and TE10 air-cap. The spray settings were as follows: 1.25 bar fan pressure; 10-15 cm target distance; and under typical atmospheric conditions. 3 bead blasted aluminium coupons were sprayed and gave THR values ranging from 1.1-1.3% at 550 nm and 1.1-1.4% at 700 nm. The masses of the coupons ranged from 73-219 mg indicating an average mass of 1-18 mg/cm⁻². Average coating thicknesses ranged between 110-262 μm.

The fog number for this paint was found to be 99 under extended SAE J1756 test conditions: 96 h at 120° C. This paint was suitable in terms of its fog number and thickness. However, the THR values of the applied coating were higher than desired; the paint lacked stability during storage so would rapidly separate out making it unsuitable for shipment; and the paint did not spray consistently as its lack of stability caused the gun to constantly block. For these reasons this paint was found to be unsuitable for its application.

### Example 5: Controlled Humidity Curing Conditions with Lower Catalyst Loading

A batch of binder, solvent, and additives was mixed to the ratio 50.1:37.4:6.9:5.3:0.3 (w/w) Acetone:Silres MSE 100:Setalux:Geniosil XL 10:DFN, using a homogenizer. Pigment was added to this mixture at a loading of 6.4% and mixed using a high shear mixer for 27 min at 4500 rpm to produce the 20 L batch of paint. Prior to spraying titanium (IV) butoxide was incorporated into the paint using a homogenizer at a loading of 2.4 wt. %. The resulting paint was sprayed using a pressure-fed Devilbiss GTI Pro-lite fitted with 0.8 fluid tip and TE10 air-cap. The spray settings were as follows: 2.5 bar fan pressure; 80 ml min⁻¹ flow rate; 1.5 bar fluid pressure; 15-20 cm target distance; and under typical atmospheric conditions. 5 fog discs prepared by buffing the substrate, oven bake at 120° C. for 3 hours and were sprayed alongside 3 bead blasted Aluminum witness coupons. The coupons gave THR values ranging from 0.6-0.7% at 700 nm and thicknesses ranging from 163-215 μm. The sprayed substrates were subsequently cured at 35° C., 50% RH for 1 hour in an environmental chamber and then baked 90° C., 30 min.

The fog number for this coating was found to be 99 under the extended SAE J1756 test conditions (96 hours at 120° C.). This promotes the idea that the previous bad fogging results (Example 2 were a result of incomplete curing due to inadequate curing conditions and not the catalyst loading.

### Example 6: Controlled Humidity Curing Conditions with Higher Catalyst Loading

A batch of binder, solvent, and additives was mixed to the ratio 50.1:37.4:6.9:5.3:0.3 (w/w) Acetone:Silres MSE 100:Setalux:Geniosil XL 10:DFN, using a homogenizer. Pigment was added to this mixture at a loading of 6.4% and mixed using a high shear mixer for 27 min at 4500 rpm to produce the 20 L batch of paint. Prior to spraying titanium (IV) butoxide was incorporated using a homogenizer at a loading of 2.4 wt. %. The resulting paint was sprayed using a pressure-fed Devilbiss GTI Pro fitted with 0.8 fluid tip and TE10 air-cap.

The spray settings were as follows: 2.0 bar fan pressure, 100 ml min⁻¹ flow rate, 1.5 bar fluid pressure; 15-20 cm target distance; and under typical atmospheric conditions.

It had a fog number of 99 after a 168 hr fog test run at 120° C., a THR of 0.85% (see FIG. 1 THR), a delta haze of <0.4%, no hydrolytic degradation, no fading from UV exposure, good handling and environmental exposure resistance, extreme temperature resistance to 180° C. without a change in THR, very good absorption from all photon arrival angles and was sprayable by conventional paint spray systems. The THR values for these coatings ranged from 0.8-0.84 at 700 nm and thicknesses ranging from 125-149 μm.

### Example 7: 2 Component Polyurethane-Based Paint

A batch of binder; solvent; and dispersant was pre-mixed to the ratio 38:61:1 (w/w) SETALUX® 1184 SS-51:ethyl acetate:Solsperse® M387 using a homogenizer. Pigment was added over 4 min whilst high shear mixing the liquid parts at 3000 rpm. Once all pigment was added the paint was high shear mixed for 4 min at 7000 rpm, the pigment loading was 25.3%. The pigment is a low structured, neutral and low VOC pigment, with a primary particle size of 11 nm. The high shear mixing is believed to have broken up larger agglomerates, it is unlikely the primary particle size was achieved. Prior to spraying an isocyanate crosslinker, Tolonate HDB 75 MX, was added to the paint at a loading of 5.3%. This paint was sprayed using a gravity-fed Devilbiss Pro-lite S spray gun fitted with 1.2 mm fluid tip and TE10 air-cap. The spray settings were as follows: 2.75 bar air pressure; 1 turn open needle; 10-15 cm target distance; 10 passes; and under typical atmospheric conditions. The resulting coating was dried at 30° C. for 15 min and then baked in an oven at 80° C. for 30 min.

The coating had a THR of 0.83% at 550 and 700 nm; and a fog number of 92%. The fog number of this coating was lower than the silicone-based materials in the Examples above and therefore was less desirable. A potential cause of this lower fog number was higher boiling point solvents not being driven off during the drying stages and uncured polymer fragments residing in the finished coating. Another likely source of fogging was believed to be the M387 dispersant.

### Example 8: Iron Oxide Pigment Paint

A batch of binder; solvent; and additives were pre-mixed to the ratio 50.1:37.4:6.9:5.3:0.3 (w/w) acetone:SILRES® MSE 100:SETALUX® 1184 SS-51:GENIOSIL® XL 10:Borchi® Gen DFN using a homogenizer. Pigment was added to this mixture at a loading of 7.3% and mixed using a high shear mixer for 3 min at 6000 rpm, 7 min at 5500 rpm, and then 5 min at 6000 rpm, to produce the 1 L batch of paint. The pigment began settling out immediately after mixing, which made it unsuitable for spray application. When painted down onto a coupon this mixture dried leaving the majority of the substrate bare, again highlighting instability of the paint. For this reason the FeO pigment was found to be incompatible with the current formulation.

### Example 9: Fluorinated Copolymer for Rheology

A batch of binder, solvent, and additives was mixed to the ratio 50.1:37.4:6.9:5.3:0.3 (w/w) Acetone:Silres MSE 100:Zeffle GK:Geniosil XL 10:DFN, using a homogenizer. Pigment was added to this mixture at a loading of 6.6% and mixed using a high shear mixer for 27 min at 4500 rpm to produce the 20 L batch of paint. Prior to spraying titanium (IV) butoxide was incorporated using a homogenizer at a loading of 2.4 wt. %. The resulting paint was sprayed using a pressure-fed Devilbiss GTI Pro fitted with 0.8 fluid tip and TE10 air-cap. The spray settings were as follows: 2.0 bar fan pressure, 100 ml min⁻¹ flow rate, 1.5 bar fluid pressure; 15-20 cm target distance; 10 passes and under typical atmospheric conditions.

The corresponding fog number for this paint was found to be 97 under the extended SAE J1756 test conditions (168 hours at 120° C.). The THR values for these coatings ranged from 1-1.3% at 700 nm and thicknesses ranging from 100-150 μm.

### Example 10: Water Based Acrylic Polyol

A batch of binder; solvent; defoamer; and dispersant was mixed to the ratio 17.8:79.2:0.1:2.9 (w/w) Macrynal SM 6826w/43WA:water:Additol VXW 6393:Borchi Gen DFN. The mixture was high shear mixed at 3000 rpm for 3 min until combined. Pigment was added at a loading of 10%, the mixture was high shear mixed for a further 6 min at 3000 rpm, and then at 5000 rpm for another 6 min. The pigment is a high structured, neutral and low VOC pigment, with a primary particle size of 11 nm. The high shear mixing is believed to have broken up larger agglomerates, it is unlikely the primary particle size was achieved. Prior to spraying an isocyanate crosslinker, Easaqua M 501, was added to the paint at a loading of 4.2%. This paint was diluted with water to reach a sprayable viscosity; it was then sprayed using a gravity-fed Devilbiss Pro-lite S spray gun fitted with 1.2 mm fluid tip and TE10 air-cap. The spray settings were as follows: 2.75 bar air pressure; 1 turn open needle; 10-15 cm target distance; 20 passes; and under typical atmospheric conditions. The resulting coating was baked in an oven at 100° C. for 1 hour.

The coating had a THR of 1.1% at 550 and 700 nm; and a fog number of 96 under the extended SAE J1756 test conditions (168 hours at 120° C.); and an average thickness of 120 μm. The fog number of this coating was lower than the silicone-based materials in the Examples above and therefore was less desirable. A potential cause of this lower fog number was believed to be the defoamer required to make a stable solution. The THR was higher than all other examples but still acceptable. The increased THR was most likely due to the higher boiling point of water compared to acetone and this higher boiling point also meant that we had to wait for the water to evaporate between each spray pass. Lastly, the waterborne coating showed poor adhesion to plastic substrates and took a high number of spray passes to reach suitable optical properties (20). It was thought adhesion could have been improved by plasma activating the polymer surface before spraying.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The disclosures in UK patent application number 2306695.4, from which this application claims priority, and in the abstract accompanying this application are incorporated herein by reference.

1. A method of coating a substrate to form a light absorbing, non-transparent film, including the steps of:
(a) providing a suspension in a solvent of:
(i) a pigment,
(ii) a binder which includes a polysiloxane, a polyol, or a combination thereof,
(iii) a rheology modifier, and
(iv) an adhesion promoter which includes a silane group;
(b) spray-coating the suspension onto the substrate with the majority of the solvent evaporating before the suspension contacts the substrate in order to result in a porous coating;
(c) repeating step (b) until the average coating thickness is at least 20 micrometres; and
(d) curing the coating in order to result in a delta-haze of less than 1 (measured to ASTM-D1003-21 through glass) and a fog number of at least 95 fog numbers as measured by an extended SAE-J1756 photometric test at 120° C. for 168 hrs with a 21° C. collector plate temperature.

2. A method as claimed in claim 1, wherein the pigment is carbon black based, or is a mineral based black such as spinel black, black titania, iron oxide, manganese oxide, mixed metal oxides.

3. A method as claimed in claim 1 wherein the pigment has a non-spherical branched structure and/or does not include any carbon nanotubes.

4. A method as claimed in claim 1 wherein the pigment has an oil absorption number (OAN) (as measured by ASTM 2414-22) from 100 cc/100 g to 630 cc/100 g.

5. A method as claimed in claim 1, wherein the pigment does not have any added functional groups through oxidation or chemical grafting.

6. A method as claimed in claim 1, wherein the binder is a methoxy-silane, an ethoxy-silane, a phenoxy-silane, or any combination thereof.

7. A method as claimed in claim 1, wherein the rheology modifier is a polyol, optionally including polar and non-polar groups, optionally wherein the rheology modifier is an acrylate polyol.

8. (canceled)

9. A method as claimed in claim 1, wherein the adhesion promoter includes an alkoxy epoxy silane or an alkoxy vinyl silane.

10. A method as claimed in claim 1, wherein the solvent is ethyl acetate, acetone, methyl ethyl ketone, or any combination thereof.

11. A method as claimed in claim 1, wherein the ratio of solvent to binder is from 1:0.6 to 1:1.15.

12. A method as claimed in claim 1, in which the evaporation of solvent in step (b) is controlled such that the resulting coating has pores which range in diameter from 100 nm to 100,000 nm.

13. A method as claimed in claim 1, wherein the pigment is particulate in form, optionally wherein the average diameter of said pigment particles is from 11 nm to 250 μm.

14. (canceled)

15. A method as claimed in claim 1, wherein the ratio of pigment to binder in step (a) is from 1:8 to 1:4.

16. A method as claimed in claim 1, wherein the solvent has a boiling point less than 90° C.

17. A method as claimed in claim 1, wherein the viscosity of the suspension of step (a) is from 1500 to 6500 cps after stirring (Brookfield viscosity).

18. A method as claimed in claim 1, wherein the coating of step (c) has a dry film density range of up to 1.3 gcm-3.

19. A method as claimed in claim 1, wherein the dry film coverage of the substrate resulting from step (b) is from 3 mg/cm² to 8 mg/cm2.

20. A method as claimed in claim 1, wherein the suspension includes a catalyst for assisting in curing the coating, optionally wherein the catalyst is titanium butoxide.

21. (canceled)

22. A method as claimed in claim 1, wherein the suspension includes a dispersant, optionally wherein the dispersant is a non-ionic dispersant and/or wherein the mass of dispersant is 4% or less of the pigment mass and/or wherein the dispersant includes hydroxyl functionality which enables the dispersant to be covalently bonded in cross-linked systems.

23-26. (canceled)

27. A method as claimed in claim 1, wherein the adhesion promoter is trimethoxy vinyl silane.

28. (canceled)
